(19) United States
(12) Patent Application Publication
(10) Pub. No.: US 2022/0153948 A1
(43) Pub. Date: May 19, 2022

(54) Soft particle foam consisting of thermoplastic polyurethane

(71) Applicant: BASF SE, Ludwigshafen am Rhein (DE)

(72) Inventors: Frank Prissok, Lemfoerde (DE); Juergen Ahlers, Ludwigshafen am Rhein (DE); Guenter Matzke, Diepholz (DE); Uwe Keppeler, Ludwigshafen am Rhein (DE); Peter Gutmann, Ludwigshafen (DE)

(73) Assignee: BASF SE, Ludwigshafen am Rhein (DE)

(21) Appl. No.: 17/432,970

(22) PCT Filed: Feb. 27, 2020
(86) PCT No.: PCT/EP2020/055121

§ 371 Date: Aug. 23, 2021

(30) Foreign Application Priority Data
Feb. 28, 2019 (EP) 19159922.4

(51) Int. Cl. C08J 9/18; C08G 18/76; C08G 18/32; C08G 18/48; C08K 5/11; C08G 18/66; C08J 9/228; C08J 9/12

(52) U.S. Cl. CPC C08J 9/18; C08G 18/7671; C08G 18/3206; C08G 18/4825; C08K 5/11; C08J 2375/08; C08J 9/228; C08J 9/122; C08J 2201/03; C08J 2203/02; C08G 18/6607

(57) ABSTRACT

A foamed pellet material contains a composition (Z1) that contains a thermoplastic polyurethane (TPU-1) and at least one plasticizer (W). The composition (Z1) has a Shore hardness within a range from 15 A to 43 A. A process can produce a foamed pellet material of this kind. The foamed pellet material can be used for the production of a molded article.

The present invention relates to a foamed pellet material comprising, a composition (Z1) that comprises a thermoplastic polyurethane (TPU-1) and at least one plasticizer (W), the composition (Z1) having a Shore hardness within a range from 15 A to 43 A, and also to a process for producing, a foamed pellet material of this kind. The present invention further encompasses the use of a foamed pellet material of the invention for the production of a molded article.

Foamed pellet materials, which are also referred to as bead foams (or particle foams), and also molded articles produced therefrom, based on thermoplastic polyurethane or other elastomers, are known (e.g. WO 94/20568, WO 2007/082838 A1, WO2017/030835, WO 2013/153190 A1, WO2010/010010) and have manifold possible uses.

For the purposes of the present invention, a “foamed pellet material” or else a “bead foam” or “particle foam” refers to a foam in bead form, in which the average diameter of the beads is from 0.2 to 20 mm, preferably 0.5 to 15 mm, and in particular from 1 to 12 mm. In the case of non-spherical, e.g. elongate or cylindrical beads, diameter means the longest dimension.

There is in principle a need for foamed pellet materials or bead foams in which processibility to the corresponding molded articles at the lowest possible temperatures is improved while maintaining advantageous mechanical properties. This is especially relevant in the fusion processes currently in widespread use, in which the input of energy for fusing the foamed pellets is introduced by an auxiliary medium, for example steam, since this will achieve improved bonding while simultaneously reducing damage to the material or to the foam structure and at the same time obtaining sufficient bonding/fusion.

Sufficient bonding/fusion of the foamed pellets is essential in order to obtain advantageous mechanical properties in the molded article produced from the foamed pellet material. If bonding/fusion of the foam beads is inadequate, the properties thereof cannot be utilized to their full extent, which has a consequent overall adverse effect on the mechanical properties of the molded article obtained. Similar considerations apply when the molded article has been weakened. In such cases, the mechanical properties are disadvantageous at the weakened points, with the same result as that mentioned above. The properties of the polymer used therefore need to be readily adjustable.

Polymers based on thermoplastic elastomers (TPE) are already used in various fields. Depending on the use, it is possible to modify the properties of the polymer. Thermoplastic polyurethanes in particular are used in a variety of ways.

Thermoplastic polyurethanes normally have a hardness from 80 Shore A to 74 Shore D. For many uses, softer materials are however advantageous. For this reason, it is state of the art for plasticizers with which the Shore hardness can be lowered to be added to thermoplastics. When selecting the plasticizer, it is particularly important to ensure that the product is compatible with the thermoplastic polyurethane. In addition, the mechanical properties of the thermoplastic polyurethane, for example the abrasion and the elastomeric properties, should not become poorer.

For example, WO 2011/141408 A2 discloses thermoplastic polyurethanes that comprise a plasticizer based on glycerol. Foams based on such thermoplastic polyurethanes are also disclosed. The foams described in WO 2011/141408 A2 are however block foams, the property profile of which is unsuitable for many uses.

In the context of the present invention, “advantageous mechanical properties” are to be understood as referring to the intended uses. The primary use for the subject matter of the present invention is use in the footwear sector, in which the foamed pellets can be used for molded articles for constituent parts of footwear in which damping and/or cushioning is relevant, for example intermediate soles and insoles.

It was thus an object of the present invention to provide foamed pellets based on thermoplastic polyurethanes that have good mechanical properties and good damping and good rebound properties. It was a further object of the present invention to provide a process for producing the corresponding foamed pellets.

This object is according to the invention achieved by a foamed pellet material comprising a composition (Z1) that comprises a thermoplastic polyurethane (TPU-1) and at least one plasticizer (W), the composition (Z1) having a Shore hardness within a range from 15 A to 43 A.

It has surprisingly been found that thermoplastic polyurethanes of this kind can be readily processed into a foamed pellet material that can in turn be readily further processed into molded articles having in particular a low modulus of elasticity and good rebound. It has surprisingly been found that foamed pellets based on a composition having a Shore hardness within a range from 15 A to 43 A result in a pellet material having good mechanical properties and can be readily processed into molded articles. Such molded articles exhibit surprisingly good rebound in relation to the low stiffness.

In the context of the present invention, it was found that the foamed pellets of the invention exhibit a good combination of damping and rebound, in particular very soft wearing-in characteristics and despite this no collapse under high mechanical stress.

It is also advantageous that the foamed pellets of the invention have a low fusion temperature.

The composition (Z1) has according to the invention a Shore hardness within a range from 15 A to 43 A, measured in accordance with DIN 53505. The Shore hardness is preferably within a range from 20 A to 43 A, more preferably within a range from 25 A to 43 A, in each case measured in accordance with DIN ISO4649_A.

In a further embodiment, the present invention also relates to a foamed pellet material as described above, the composition (Z1) having a Shore hardness within a range from 20 A to 43 A.

It was surprisingly found that the melting range and the melt flow rate of the composition (Z1) also have a distinct effect on the properties of the foamed pellet material. In a further embodiment, the present invention accordingly also relates to a foamed pellet material as described above, wherein the melting range of the composition (Z1) begins below 100° C. in a DSC measurement with a heating rate of 20 K/min and in which the composition (Z1) at 180° C. and an applied weight of 21.6 kg in accordance with DIN EN ISO 1133 has a maximum melt flow rate (MFR) of 250 g/10 min.

The composition (Z1) comprises according, to the invention a thermoplastic polyurethane (TPU-1) and a plasticizer (W). In the context of the present invention the composition (Z1) may comprise further components, for example also further thermoplastic: polyurethanes or further plasticizers.

In principle, all plasticizers having adequate compatibility with the thermoplastic polyurethane (TPU-1) are according to the invention suitable. Citric acid derivatives and glycerol derivatives and mixtures of compounds have in particular been found to be suitable as plasticizers. In the context of the present invention, preference is given to using as plasticizer (W) glycerol derivatives, more preferably derivatives of glycerol, wherein at least one glycerol hydroxyl group has been esterified with a monocarboxylic acid (ii) having 1, 2, 3, 4, 5 or 6 carbon atoms, preferably 2, 3 or 4 carbon atoms, more preferably 2 carbon atoms. This group of substances is referred to hereinbelow as glycerol carboxylic esters. Glycerol tricarboxylic esters are more preferred and glycerol triacetate particularly preferred.

In a further embodiment, the present invention also relates to a foamed pellet material as described above, wherein the plasticizer (W) is selected from derivatives of citric acid and of glycerol or mixtures of two or more thereof, wherein at least one glycerol hydroxyl group has been esterified with a monocarboxylic acid having 1, 2, 3, 4, 5 or 6 carbon atoms.

In addition to excellent mechanical stability of the plastics plasticized with the plasticizer of the invention, these plasticizers show a low tendency to blooming and are also non-toxic or have only low toxicity compared to other plasticizers. They also show high stability toward the temperatures occurring during TPU processing, the mechanical properties of the TPU at the same time not being adversely affected during processing.

The raw materials required for their production can preferably be obtained from renewable sources. Good compatibility with other, polar plasticizers, in particular esters of tricarboxylic acids, affords the possibility of plasticizer combinations as a means of achieving a material modification or the setting of specific properties, such as particularly low Shore hardnesses.

Further advantages of the plasticizers of the invention are that they have good miscibility also with polar polyurethanes, which means it is possible to incorporate significantly higher proportions of plasticizer, resulting in lower Shore A hardnesses.

Compounds typically used as plasticizers that have urethane linkages, for example low-molecular-weight polyurethanes, are also suitable as plasticizers. Also suitable are for example diphenyl cresyl phosphate (DPK) or also phthalates.

In a preferred embodiment, in addition to the plasticizer (W) of the invention, at least one further plasticizer (W2) is used, which is preferably an ester of a tricarboxylic acid.

In a further embodiment, the present invention also relates to a foamed pellet material as described above wherein the composition (Z1) comprises an ester of a tricarboxylic acid as a plasticizer (W2).

Said tricarboxylic acid preferably has an aliphatic structure, the aliphatic structure being branched and having 4 to 30 carbon atoms, more preferably 4 to 20 carbon atoms, particularly preferably 5 to 10 carbon atoms, and most preferably 6 carbon atoms. The carbons in the branched aliphatic structure are connected to one another directly via a single or double bond. The aliphatic structure preferably has only single bonds between the carbons. In a further preferred embodiment, the tricarboxylic acid contains at least one hydroxyl group. The at least one hydroxyl group is directly connected to a carbon atom of the above-described aliphatic structure of the tricarboxylic acid such that the at least one hydroxyl group is attached to the aliphatic structure in addition to the three acid groups. It is particularly preferable for there to be exactly one hydroxyl group on the aliphatic structure of the tricarboxylic acid. .A particularly preferred tricarboxylic acid is citric acid.

In a preferred embodiment, all three acid groups of the tricarboxylic acid have been esterified with an alcohol. The alcohols may have aromatic and/or aliphatic structures. More preferred are alcohols having 1 to 30 carbon atoms, more preferably 1 to 20 carbon atoms, more preferably 1 to 10 carbon atoms, more preferably 1 to 8 carbon atoms, and particularly preferably 1 to 6 carbon atoms. Preference is given to using alcohols having an aliphatic structure, alcohols having linear aliphatic structures being further preferred, and aliphatic structures that have no double bonds being particularly preferred.

In a further preferred embodiment, the alcohols have a multiple of 2 carbon atoms, i.e. 2, 4, 6, 8, 10, 12, 14, 16, 18 or 20 carbon atoms. The alcohols are more preferably linear aliphatics.

In a very particularly preferred embodiment, the alcohol is ethanol, in a second very particularly preferred embodiment, the alcohol is a butanol. In an alternative embodiment, the alcohol is propanol. More preferably, all three acid groups of the tricarboxylic acid have been esterified with the same alcohol.

In further preferred embodiments, the at least one hydroxyl group of the tricarboxylic acid has been additionally esterified with a carboxylic acid. The carboxylic acid is selected from aromatic or aliphatic carboxylic acids having 1 to 40 carbon atoms, more preferably 1 to 30 carbon atoms, particularly preferably 2 to 22 carbon atoms, which are more preferably linearly arranged and in further preferred embodiments the number of carbon atoms is a multiple of 2. The hydroxyl group has very particularly preferably been esterified with an acetic acid.

In further preferred embodiments, the at least one hydroxyl group of the tricarboxylic acid has been etherified with the radical ROH. The ROH radical comprises 1 to 40 carbon atoms, more preferably 1 to 30 carbon atoms, particularly preferably 2 to 22 carbon atoms, wherein in particularly preferred embodiments the number of carbon atoms is a multiple of 2 and more preferably this alcohol has a linear aliphatic structure. In further preferred embodiments, it is polyethylene glycol or polypropylene glycol. Polyethylene glycol is further preferred. In the abovementioned embodiments, aside from the oxygen atoms of the three carboxyl groups of the tricarboxylic acid and of the hydroxyl group thereof, there are preferably no other heteroatoms present in the ester. In alternative embodiments, the tricarboxylic acid contains at least one amine group. In preferred embodiments, a carboxylic acid forms an acid amide with this amine group. This carboxylic acid is selected from aromatic or aliphatic carboxylic acids having 1 to 40 carbon atoms, more preferably 1 to 30 carbon atoms, particularly preferably 1 to 22 carbon atoms, wherein in particularly preferred embodiments the number of carbon atoms in the carboxylic acid is a multiple of 2.

In further preferred embodiments, the at least one amine group of the tricarboxylic acid forms a secondary amine with at least one radical R′ or a tertiary amine with a second radical R″. The radicals R′ and R″ each independently have 1 to 40 carbon atoms, more preferably 1 to 30 carbon atoms, particularly preferably 2 to 22 carbon atoms, wherein in particularly preferred embodiments the number of carbon atoms in the carboxylic acid is a multiple of 2. In further preferred embodiments, the radical is a polyethylene glycol or polypropylene glycol, preferably polyethylene glycol.

In a very particularly preferred embodiment, the ester of a tricarboxylic acid used as a second plasticizer is tributyl 2-acetoxy-1,2,3-tricarboxylate.

For use as a plasticizer in polyurethanes, a glycerol carboxylic ester, preferably a glycerol tricarboxylic ester, having the lowest possible acid value is advantageous, since free acid groups can contribute to the degradation of polyester-polyurethanes optionally used and thus adversely affect the stability thereof. In some preferred embodiments, one, two or three hydroxyl groups of the glycerol have been esterified with a monocarboxylic acid, preferably two or three of the hydroxyl groups have been esterified with at least one carboxylic acid, and particularly preferably all three hydroxyl groups of the glycerol have been esterified with a monocarboxylic acid.

In some preferred embodiments, different monocarboxylic acids are present in the glycerol ester. In other preferred embodiments, the esterified hydroxyl groups of the glycerol have been esterified with the same monocarboxylic acid. The plasticizers of the invention preferably have as intrinsic color a haze value of less than 100, more preferably less than 50, in particular less than 30.

The plasticizers (W) preferably have an alkali content of less than 40 ppm, more preferably less than 15 ppm, in particular less than 5 ppm.

The plasticizers (W) of the invention normally have a water content of less than 0.2% by weight, preferably less than 0.05% by weight, more preferably less than 0.02% by weight.

The plasticizer (W) of the invention is present in the composition (Z1) for example in an amount of 1% to 80% by weight, preferably in an amount of 1% to 60% by weight, more preferably of 5% to 50% by weight, in particular of 10% to 40% by weight, in each case based on the total weight of the composition (Z1).

In a further embodiment, the present invention also relates to a foamed pellet material as described above, the plasticizer (W) being present in the composition (Z1) in an amount within a range from 1% to 60% by weight based on the total composition (Z1).

If a further plasticizer (W2) is used, the ratio of the plasticizers used may vary within wide ranges. For example, plasticizer (W2) and plasticizer (W) may be used in a weight ratio within a range from 2:1 to 1:10, more preferably in a weight ratio within a range from 1:1 to 1:5, and most preferably in a weight ratio within a range from 1:1.5 to 1:3.

The composition (Z1) comprises according to the invention a thermoplastic polyurethane (TPU-1).

The production of thermoplastic polyurethanes is in principle known. Isocyanates and isocyanate-reactive compounds, in particular polyols, and optionally chain extenders are normally employed in the production of thermoplastic polyurethanes.

Suitable polyols are in principle known to those skilled in the art and described for example in “Kunststoffhandbuch” [Plastics handbook], volume 7, “Polyurethane” [Polyurethanes], Carl Hanser Verlag, 3rd edition 1993, chapter 3.1. Particular preference is given to using, as polyol (P1), polyesterols or polyetherols as polyols. It is likewise possible to use polycarbonates. Copolymers may also be used in the context of the present invention. Particular preference is given to polyether polyols. The number-average molecular weight of the polyols used according to the invention is preferably within a range from 500 to 5000 g/mol, for example within a range from 550 g/mol to 2000 g/mol, preferably within a range from 600 g/mol to 1500 g/mol, in particular between 650 g/mol and 1000 g/mol.

Polyetherols, but also polyesterols, block copolymers, and hybrid polyols such as poly(ester/amide), are according to the invention suitable. Preferred polyetherols are according to the invention polyethylene glycols, polypropylene glycols, polyadipates, polycarbonates, polycarbonate diols, and polycaprolactone.

In a further embodiment, the present invention accordingly relates to a foamed pellet material as described above, the polyol composition comprising a polyol selected from the group consisting of polyetherols, polyesterols, polycaprolactone polyols, and polycarbonate polyols.

Suitable polyols are for example those having ether and ester blocks, for example polycaprolactone having polyethylene oxide or polypropylene oxide end blocks, or else polyethers having polycaprolactone end blocks. Preferred polyetherols are according to the invention polyethylene glycols and polypropylene glycols. Further preference is given to polycaprolactone.

It is also possible in accordance with the invention to use mixtures of different polyols. The polyols/polyol composition used preferably have/has an average functionality of between 1.8 and 2.3, preferably between 1.9 and 2.2, in particular 2. The polyols used in accordance with the invention preferably have solely primary hydroxyl groups.

In an embodiment of the present invention, a polyol composition (PZ) is used that comprises at least polytetrahydrofuran. The polyol composition may according to the invention also comprise further polyols in addition to polytetrahydrofuran.

Further polyols that are according to the invention suitable are for example polyethers, but also polyesters, block copolymers, and also hybrid polyols such as poly(ester/amide). Suitable block copolymers are for example those having ether and ester blocks, for example polycaprolactone having polyethylene oxide or polypropylene oxide end blocks, or else polyethers having polycaprolactone end blocks. Preferred polyetherols are according to the invention polyethylene glycols and polypropylene glycols. As a further polyol, further preference is given to polycaprolactone.

In a particularly preferred embodiment, the polytetrahydrofuran has a number-average molecular weight Mn within a range from 500 g/mol to 5000 g/mol, more preferably within a range from 550 to 2500 g/mol, particularly preferably within a range from 650 to 2000 g/mol.

The composition of the polyol composition (PZ) may in the context of the present invention vary within wide ranges. The polyol composition may also contain mixtures of different polyols.

The polyol composition may according to the invention also comprise a solvent. Suitable solvents are known per se to those skilled in the art.

When polytetrahydrofuran is used, the number-average molecular weight Mn of the polytetrahydrofuran is preferably within a range from 500 to 5000 g/mol. The number-average molecular weight. Mn of the polytetrahydrofuran is further preferably within a range from 500 to 2000 g/mol.

In a further embodiment, the present invention also relates to a foamed pellet material as described above, the polyol composition comprising a polyol selected from the group consisting of polytetrahydrofurans having a number-average molecular weight Mn within a range from 500 g/mol to 5000 g/mol.

In a further embodiment, the present invention accordingly relates to a foamed pellet material as described above, the polyol composition comprising a polyol selected from the group consisting of polytetrahydrofurans having a number-average molecular weight Mn within a range from 500 g/mol to 2000 g/mol.

Mixtures of various polytetrahydrofurans may according to the invention also be used, that is to say mixtures of polytetrahydrofurans having different molecular weights.

Preferred polyetherols are according to the invention polyethylene glycols, polypropylene glycols, and polytetrahydrofurans, and also mixed polyetherols thereof. Also employable according to the invention are for example mixtures of various polytetrahydrofurans differing in molecular weight.

Polyesterols may also be used. Polyester polyols based on adipic acid, ethylene glycol, and butanediol are for example suitable.

In a further embodiment, the present invention also relates to a foamed pellet material as described above, wherein the thermoplastic polyurethane (TPU-1) is produced using a polyol (P1) selected from the group consisting of polyetherols, polyesterols, polycarbonate alcohol's, and hybrid polyols.

Normally, at least one chain extender (KV) is additionally used. Suitable chain extenders are known per se to those skilled in the art. Chain extenders are for example compounds having two groups reactive toward isocyanate groups, especially those having a molecular weight of less than 500 g/mol. Suitable chain extenders are for example diamines or diols. Further preference is according to the invention given to diols. In the context of the present invention, it is also possible to use mixtures of two or more chain extenders.

Suitable diols are in principle known to those skilled in the art. The diol preferably has according to the invention a molecular weight of <500 g/mol. It is possible here in accordance with the invention to use for example aliphatic, araliphatic, aromatic and/or cycloaliphatic diols having a molecular weight of 50 g/mol to 220 g/mol as chain extender. Preference is given to alkanediols having 2 to 10 carbon atoms in the alkylene radical, in particular di-, tri-, tetra-, penta-, hexa-, hepta-, octa-, nona- and/or decaalkylene glycols. For the present invention, particular preference is given to 1,2-ethylene glycol, propane-1,3-diol, butane-1,4-diol, hexane-1,6-diol.

Suitable chain extenders (KV1) in the context of the present invention are also branched compounds such as cyclohexane-1,4-dimethanol, 2-butyl-2-ethylpropanediol, neopentyl glycol, 2,2,4-trimethylpentane-1,3-diol, pinacol, 2-ethylhexane-1,3-diol or cyclohexane-1,4-diol.

In a further embodiment, the present invention accordingly relates to a foamed pellet material as described above, wherein the chain extender (KV1.) is selected from the group consisting of propane-1,3-diol, ethane-1,2-diol, butane-1,4-diol, hexane-1,6-diol, and HQEE.

In a further embodiment, the present invention also relates to a foamed pellet material as described above, wherein the thermoplastic polyurethane (TPU-1) is produced using a chain extender (KV) selected from the group consisting of 1,2-ethylene glycol, propane-1,3-diol, butane-1,4-diol, and hexane-1,6-diol.

Suitable isocyanates in the context of the present invention are especially diisocyanates, especially aliphatic or aromatic diisocyanates, more preferably aromatic diisocyanates.

In addition, it is in the context of the present invention possible to use as the isocyanate component pre-reacted products in which some of the OH components have been reacted with an isocyanate in a preceding reaction step. The products obtained are in a subsequent step, the actual polymer reaction, reacted with the remaining OH components thus forming the thermoplastic polyurethane.

Aliphatic diisocyanates used are customary aliphatic and/or cycloaliphatic diisocyanates, for example tri-, tetra-, penta-, hexa-, hepta- and/or octamethylene diisocyanate, hexamethylene diisocyanate (HDI), 2-methylpentamethylene 1,5-diisocyanate, 2-ethyltetramethylene 1,4-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylenedicyclohexyl 4,4′-, 2,4′- and/or 2,2′-diisocyanate (H12MDI).

Suitable aromatic diisocyanates are in particular naphthylene 1,5-diisocyanate (NDI), tolylene 2,4 and/or 2,6-diisocyanate (TDI), 3,3′-dimethyl-4,4′-diisocyanatobiphenyl (TODI), p-phenylene diisocyanate (PDI), diphenylethane 4,4′-diisocyanate (EDI), methylene diphenyl diisocyanate (MDI), where the term MDI is understood as meaning diphenylmethane 2,2′-, 2,4′- and/or 4,4′-diisocyanate, dimethyldiphenyl 3,3′-diisocyanate, diphenylethane 1,2-diisocyanate and/or phenylene diisocyanate or H12MDI (methylenedicyclohexyl 4,4′-diisocyanate).

Mixtures may in principle also be used. Examples of mixtures are mixtures comprising at least one further methylene diphenyl diisocyanate besides methylene diphenyl 4,4′-diisocyanate. The term “methylene diphenyl diisocyanate” here refers to diphenylmethane 2,2′-, 2,4′- and/or 4,4′-diisocyanate or a mixture of two or three isomers. It is therefore possible to use as further isocyanate for example diphenylmethane 2,2′- or 2,4′-diisocyanate or a mixture of two or three isomers. In this embodiment, the polyisocyanate composition may also comprise other abovementioned polyisocyanates.

Preferred examples of higher-functionality isocyanates are triisocyanates, for example triphenylmethane 4,4′,4″-triisocyanate, also the cyanurates of the abovementioned diisocyanates, and also the oligomers obtainable by partial reaction of diisocyanates with water, for example the biurets of the abovementioned diisocyanates, and also oligomers obtainable by controlled reaction of semiblocked diisocyanates with polyols having an average of more than two and preferably three or more hydroxy groups.

Organic isocyanates used may be aliphatic, cycloaliphatic, araliphatic and/or aromatic isocyanates.

Crosslinkers may additionally also be used, for example the previously mentioned higher-functionality polyisocyanates or polyols, or else other higher-functionality molecules having a plurality of isocyanate-reactive functional groups. It is likewise possible in the context of the present invention to achieve crosslinking of the products by having the employed isocyanate groups present in excess in relation to the hydroxyl groups. Examples of higher-functionality isocyanates are triisocyanates, for example triphenylmethane 4,4′,4″-triisocyanate, and isocyanurates, and also the cyanurates of the abovementioned diisocyanates, and the oligomers obtainable by partial reaction of diisocyanates with water, for example the biurets of the abovementioned diisocyanates, and also oligomers obtainable by controlled reaction of semiblocked diisocyanates with polyols having an average of more than two and preferably three or more hydroxy groups.

In the context of the present invention, the amount of crosslinker, that is to say of higher-functionality isocyanates and higher-functionality polyols/higher-functionality chain extenders, is here not more than 3% by weight, preferably less than 1% by weight, more preferably less than 0.5% by weight, based on the total mixture of the components.

Further, the polyisocyanate composition may also comprise one or more solvents. Suitable solvents are known to those skilled in the art. Suitable examples are nonreactive solvents such as ethyl acetate, methyl ethyl ketone, and hydrocarbons.

In a further embodiment, the present invention also relates to a foamed pellet material as described above, wherein the thermoplastic polyurethane (TPU-1) is produced using a diisocyanate selected from the group consisting of diphenylmethane 2,2′-, 2,4′- and/or 4,4′-diisocyanate (MDI), tolylene 2,4- and/or 2,6-diisocyanate (TDI), methylenedicyclohexyl 4,4′-, 2,4′- and/or 2,2′-diisocyanate (H12MDI), hexamethylene diisocyanate (HDI), and 1-isocyanato-3,3,5-trimethyl-5-isocyanatomethylcyclohexane (IPDI).

The relative amounts of the components used may vary within wide ranges. For example, isocyanate and polyol are used in a weight ratio within a range from 1:7 to 1:1.5, preferably within a range from 1:5 to 1:3.

The reaction may be carried out at customary indices, preferably at an index from 60 to 130, more preferably at an index from 80 to 110. The index is defined by the ratio of the total isocyanate groups used in the reaction to the isocyanate-reactive groups, i.e. the active hydrogens, the polyol component, and the employed chain extender. An index of 100 corresponds to one active hydrogen atom, i.e. to one isocyanate-reactive function, per isocyanate group. At indices above 100 there are more isocyanate groups than OH groups present.

In the production of thermoplastic polyurethanes, catalysts and/or customary auxiliaries may also be added.

Catalysts that in particular accelerate the reaction between the NCO groups of the diisocyanates and the hydroxyl groups of the isocyanate-reactive compound and the chain extender are in a preferred embodiment tertiary amines, in particular triethylamine, dimethylcyclohexylamine, N-methylmorpholine, N,N′-dimethylpiperazine, 2-(dimethylaminoethoxy)ethanol, diazabicyclo[2.2.2]octane; in another preferred embodiment, these are organic metal compounds such as titanate esters, iron compounds, preferably acetylacetonate, tin compounds, preferably tin diacetate, tin dioctoate, tin dilaurate or the dialkyitin salts of aliphatic carboxylic acids, preferably dibutyltin diacetate, dibutyitin dilaurate.

The catalysts are preferably used in amounts of 0.0001 to 0.1 parts by weight per 100 parts by weight of isocyanate-reactive compound. Preference is given to using tin catalysts, in particular tin dioctoate. In addition to catalysts, customary auxiliaries may also be added to the structural components in addition to the plasticizers (W) of the invention. Examples include surface-active substances, fillers, flame retardants, nucleation agents, oxidation stabilizers, lubricants and demolding aids, dyes and pigments, optionally further stabilizers in addition to the stabilizers of the invention, for example against hydrolysis, light, heat or discoloration, inorganic and/or organic fillers, reinforcers and plasticizers. Hydrolysis inhibitors used are preferably oligomeric and/or polymeric aliphatic or aromatic carbodiimides. In order to stabilize the TPU of the invention against ageing, stabilizers may preferably be added to the TPU. Stabilizers are for the purposes of the present invention additives that protect a plastic or a plastics mixture from damaging environmental effects. Examples include primary and secondary antioxidants, hindered amine light stabilizers, UV absorbers, hydrolysis stabilizers, quenchers and flame retardants. Examples of commercial stabilizers may be found in the Plastics Additive Handbook, 5th edition, H. Zweifel, ed., Hanser Publishers, Munich, 2001 ([1]), pages 98-136. More detailed information on the abovementioned auxiliaries and additives can be found in the technical literature, for example in the Plastics Additive Handbook, 5th edition, H. Zweifel, ed, Hanser Publishers, Munich, 2001, pages 98-136.

The TPUs may be produced continuously by the known processes, for example using reactive extruders or the belt process by the “one-shot” process or the prepolymer process, or discontinuously by the known prepolymer process.

In these processes, the components to be reacted may be mixed with one another successively or simultaneously, with immediate onset of the reaction. In the extruder process the structural components are introduced into the extruder individually or as a mixture, reacted preferably at temperatures of 100° C. to 280° C., more preferably 140° C. to 250° C., and the TPU obtained is extruded, cooled, and pelletized.

In a preferred embodiment, at least the plasticizer (W) for the production of the thermoplastic polyurethane, preferably optionally also at least one second plasticizer (W2), is added during and/or after production of the thermoplastic material. In a preferred embodiment, the plasticizer is metered into at least one of the starting materials in the production of the TPU; in another preferred embodiment, it is mixed with the TPU that has already been produced, preferably in an extruder. The thermoplastic polyurethane may undergo further thermoplastic processing without the effect of the plasticizers of the invention being lost.

In the case of the production of TPU, it is further preferable to add it in parallel to the components used.

In a further aspect, the present invention also relates to a process for producing a foamed pellet material. In this case, the present invention relates to a process for producing a foamed pellet material, comprising the steps of
(i) providing a composition (Z1) that comprises a thermoplastic polyurethane (TPU-1) and at least one plasticizer (W), the composition (Z1) having a Shore hardness within a range from 15 A to 43 A;
(ii) impregnating the composition (Z1) with a blowing agent under pressure;
(iii) expanding the composition (Z1) by means of a pressure drop.

In the context of the present invention, the composition (Z1) may be used in the form of a melt or in the form of a pellet material.

The present invention accordingly in a further embodiment also relates to a process for producing a foamed pellet material, comprising the steps of
(i) extruding a composition (Z1) that comprises a thermoplastic polyurethane (TPU-1) and at least one plasticizer (W), the composition (Z1) having a Shore hardness within a range from 15 A to 43 A, to obtain a pellet material having an average diameter within a range from 0.2 to 10 mm;
(ii) impregnating the pellet material under pressure with 0.1% to 40% by weight of a blowing agent, based on the total weight of the pellet material, and then
(iii) depressurizing to obtain a foamed pellet material.

As regards preferred embodiments of the process, suitable starting materials or mixing ratios, reference is made to the statements above which apply correspondingly.

Processes for producing foamed pellets starting from thermoplastic polyurethanes are known per se. In the context of the present invention, it has proven advantageous to use butane, propane, pentane, carbon dioxide, and nitrogen as blowing agents.

In a further embodiment, the present invention also relates to a process for producing a foamed pellet material as described above, wherein the blowing agent is selected from the group consisting of butane, propane, pentane, carbon dioxide, and nitrogen.

The process of the invention may comprise further steps, for example temperature adjustments.

The unexpanded polymer mixture of the composition (Z1) that is needed for the production of the foamed pellet material is produced in a known manner from the individual components and also optionally further components such as processing aids, stabilizers, compatibilizers or pigments. Examples of suitable processes are customary mixing processes with the aid of a kneader, in continuous or batchwise mode, or with the aid of an extruder, for example a co-rotating twin-screw extruder.

In the case of compatibilizers or auxiliaries such as stabilizers, these may also already be incorporated into the components during the production of the latter. The individual components are usually combined before the mixing process, or metered into the apparatus that performs the mixing. In the case of an extruder, the components are all metered into the intake and conveyed together into the extruder, or individual components are added in via a side feed.

Processing takes place at a temperature at which the components are present in a plastic state. The temperature depends on the softening melting ranges of the components, but must be below the decomposition temperature of each component. Additives such as pigments or fillers or other customary auxiliaries mentioned above are not melted concomitantly, but are incorporated in the solid state.

Further embodiments in accordance with standard methods are possible here: the processes used in the production of the starting materials may be integrated directly into production.

Some of the abovementioned customary auxiliaries may be added to the mixture in this step.

The bead foams of the invention generally have a bulk density of from 50 g/l to 200 g/l, preferably 60 g/l to 180 g/l, more preferably 80 g/l to 150 g/l. The bulk density is measured in analogous manner to DIN ISO 697, but, in a departure from the standard, the above values are determined using a vessel having a volume of 10 I instead of a vessel having a volume of 0.5 I, since measurement using only 0.5 I volumes is too inaccurate, especially for foam beads having low density and high mass.

As stated above, the diameter of the individual beads of the foamed pellet material is from 0.5 to 30 mm, preferably 1 to 15 mm, and in particular from 3 to 12 mm. In the case of non-spherical, for example elongate or cylindrical foamed pellets, diameter means the longest dimension.

The foamed pellet material can be produced by standard methods known in the prior art by means of
(i) providing a composition (Z) of the invention;
(ii) impregnating the composition with a blowing agent under pressure;
(iii) expanding the composition by means of a pressure drop.

The amount of blowing agent is preferably 0.1 to 40 parts by weight, especially 0.5 to 35 parts by weight, and particularly preferably 1 to 30 parts by weight, based on 100 parts by weight of the amount of composition (Z) used.

One embodiment of the abovementioned process comprises
(i) providing a composition (Z) of the invention in the form of pellets;
(ii) impregnating the pellets with a blowing agent under pressure;
(iii) expanding the pellet material by means of a pressure drop.

A further embodiment of the abovementioned process comprises a further step:
(i) providing a composition (Z) of the invention in the form of pellets;
(ii) impregnating the pellet material with a blowing agent under pressure;
(iii-a) reducing We pressure to standard pressure without foaming the pellet material, optionally by prior reduction of the temperature,
(iii-b) foaming the pellet material by means of an increase in temperature.

The unexpanded pellet material here preferably has an average minimum diameter of 0.2-10 mm (determined via 3D evaluation of the pellet material, for example via dynamic image analysis with the use of a PartAn 3D optical measuring apparatus from Microtrac).

The individual pellets generally have an average mass within a range from 0.1 to 50 mg, preferably within a range from 4 to 40 mg, and more preferably within a range from 7 to 32 mg. This average mass of the pellets (particle weight) is determined as the arithmetic average by weighing three batches of 10 pellet particles each.

One embodiment of the abovementioned process comprises impregnating the pellets with a blowing agent under pressure and subsequently expanding the pellets in steps (I) and (II):
(I) impregnating the pellets in the presence of a blowing agent under pressure at elevated temperatures in a suitable, closed reaction vessel (e.g. autoclaves)
(II) sudden depressurization without cooling.

The impregnation in step (I) can take place here in the presence of water and optionally suspension auxiliaries, or solely in the presence of the blowing agent and in the absence of water.

Suitable suspension auxiliaries are, for example, water-insoluble inorganic stabilizers, such as tricalcium phosphate, magnesium pyrophosphate, metal carbonates; and also polyvinyl alcohol and surfactants, such as sodium dodecylarylsulfonate. They are typically used in amounts of 0.05% to 10% by weight based on the composition of the invention.

Depending on the chosen pressure, the impregnation temperatures are within a range from 100° C.-200° C., the pressure in the reaction vessel being between 2-150 bar, preferably between 5 and 100 bar, more preferably between 20 and 60 bar, the impregnation time generally being from 0.5 to 10 hours.

The performance of the process in suspension is known to those skilled in the art and has been described extensively in WO2007/082838, for example.

In the case of performance of the process in the absence of blowing agent, care must be taken to avoid aggregation of the polymer pellet material.

Suitable blowing agents for performing the process in a suitable closed reaction vessel are for example organic liquids and gases that are in a gaseous state under the processing conditions, such as hydrocarbons or inorganic gases or mixtures of organic liquids or gases with inorganic gases, which may also be used in combination.

Examples of suitable hydrocarbons are halogenated or non-halogenated, saturated or unsaturated aliphatic hydrocarbons, preferably non-halogenated, saturated or unsaturated aliphatic hydrocarbons.

Preferred organic blowing, agents are saturated, aliphatic hydrocarbons, in particular those having 3 to 8 carbon atoms, for example butane or pentane.

Suitable inorganic gases are nitrogen, air, ammonia or carbon dioxide, preferably nitrogen or carbon dioxide, or mixtures of the abovementioned gases.

In a further embodiment, the impregnation of the pellet material with a blowing agent under pressure comprises processes and subsequent expansion of the pellet material in steps (α) and (β):
(α) impregnating, the pellet material in the presence of a blowing agent under pressure at elevated temperatures in an extruder
(β) pelletizing the composition emerging from the extruder under conditions that prevent uncontrolled foaming.

Suitable blowing agents in this process variant are volatile organic compounds having a boiling point at standard pressure, 1013 mbar, of −25° C. to 150° C., in particular −10° C. to 125° C. Of good suitability are hydrocarbons (preferably halogen-free), especially C4-10 alkanes, for example the isomers of butane, of pentane, of hexane, of heptane and of octane, particularly preferably isopentane. Other possible blowing agents are also more sterically demanding compounds such as alcohols, ketones, esters, ethers, and organic carbonates.

The composition is here mixed in step (ii) in an extruder under pressure, with melting, with the blowing agent, which is supplied to the extruder. The blowing agent-containing mixture is extruded and pelletized under pressure, preferably with backpressure controlled to a moderate level (e.g. underwater pelletization). This is accompanied by foaming of the melt strand, with pelletization affording the bead foams.

The performance of the process via extrusion is known to those skilled in the art and has been described, by way of example, extensively in WO2007/082838, and also in WO 2013/153190 A1.

Extruders that can be used are any of the customary screw-based machines, in particular single-screw and twin-screw extruders (e.g. ZSK type from Werner & Pfleiderer), co-kneaders, Kombiplast machines, MPC kneading mixers, FCM mixers, KEX kneading screw extruders, and shear-roll extruders, as described for example in Saechtling (ed.), Kunststoff-Taschenbuch [Plastics handbook], 27th edition, Hanser-Verlag, Munich 1998, chapters 3.2.1 and 3.2.4. The extruder is usually operated at a temperature at which the composition (Z1) is present as a melt, for example at 120° C. to 250° C., in particular 150 to 210° C., and at a pressure, after addition of the blowing agent, of 40 to 200 bar, preferably 60 to 150 bar, more preferably 80 to 120 bar, in order to ensure homogenization of the blowing agent with the melt.

The process can here be carried out in an extruder or in an arrangement composed of one or more extruders. For example, the components can in a first extruder be melted and blended and a blowing agent injected. In the second extruder, the impregnated melt is homogenized and the temperature and/or the pressure adjusted. If, for example, three extruders are combined with one another, the mixing of the components and the injection of the blowing agent can likewise be split between two different process sections. If, as is preferred, only one extruder is used, all of the process steps—melting, mixing, injection of the blowing agent, homogenization, and adjustment of the temperature and/or of the pressure—are carried out in a single extruder.

As an alternative and in accordance with the methods described in WO 2014/150122 or WO 2014/150124 A1, the corresponding foamed pellet material, which may even already have been colored, can be produced directly from the pellet material by saturating the corresponding pellet material with a supercritical liquid, removing it from the supercritical liquid, and then
(i′) immersing the article in a heated fluid or
(ii′) irradiating the article with high-energy radiation (e.g. infrared or microwave irradiation).

Examples of suitable supercritical liquids are those described in WO2014150122 or, for example carbon dioxide, nitrogen dioxide, ethane, ethylene, oxygen or nitrogen, preferably carbon dioxide or nitrogen.

The supercritical liquid may here also comprise a polar liquid having a Hildebrand solubility parameter equal to or greater than 9 MPa^{-1/2}.

The supercritical fluid or the heated fluid may here also comprise a dye, with the result that a colored foamed article is obtained.

The present invention further provides a molded article produced from the foamed pellets of the invention.

The corresponding molded articles can be produced by methods known to those skilled in the art.

A process preferred here for the production of a foam molding comprises the following steps:
(A) introducing the foamed pellets of the invention into an appropriate mold;
(B) fusing the foamed pellets of the invention from step (i).

The fusing in step (B) is preferably effected in a closed mold, wherein the fusing can be effected by means of steam, hot air (as described for example in EP1979401B1) or high-energy radiation (microwaves or radio waves).

The temperature during the fusing of the foamed pellet material is preferably below or close to the melting temperature of the polymer from which the foamed pellet material was produced. For the standard polymers, the temperature for the fusing of the foamed pellet material is accordingly between 100° C. and 180° C, preferably between 120 and 150° C.

Temperature profiles/residence times can be determined individually here, for example in analogous manner to the processes described in US20150337102 or EP2872309B1.

Fusion by means of high-energy radiation is generally effected in the frequency range of microwaves or radio waves, optionally in the presence of water or of other polar liquids, for example microwave-absorbing hydrocarbons having polar groups (for example esters of carboxylic acids and of diols or of triols, or glycols and liquid polyethylene glycols), and can be effected in analogous manner to the processes described in EP3053732A or WO16146537.

As stated above, the foamed pellet material may also comprise dyes. Dyes may be added here in various ways.

In one embodiment, the foamed pellets produced may be colored after production. In this case, the corresponding foamed pellets are contacted with a carrier liquid comprising a dye, the carrier liquid (TF) having a polarity suitable for sorption of the carrier liquid into the foamed pellet material. This can be carried out in analogous manner to the methods described in the EP patent application filed under application number 17198591.4.

Examples of suitable dyes are inorganic or organic pigments. Examples of suitable natural or synthetic inorganic pigments are carbon black, graphite, titanium oxides, iron oxides, zirconium oxides, cobalt oxide compounds, chromium oxide compounds, copper oxide compounds. Examples of suitable organic pigments are azo pigments and polycyclic pigments.

In a further embodiment, the color may be added during production of the foamed pellet material. For example, the dye may be added to the extruder during production of the foamed pellet material via extrusion.

As an alternative, material that has already been colored may be used as starting material for the production of the foamed pellet material, this being extruded or expanded in the closed vessel by the processes mentioned above.

In addition, in the process described in WO2014150122, the supercritical liquid or the heated liquid may comprise a dye.

As stated above, the molded articles according to the invention have advantageous properties for the abovementioned uses in the shoe and sports shoe sector requirement.

The tensile properties and compression properties of the molded articles produced from the foamed pellets are here characterized in that the tensile strength is above 600 kPa (DIN EN ISO 1798, April 2008) and the elongation at break is above 100% (DIN EN ISO 1798, April 2008).

The resilience of the molded articles produced from the foamed pellets is above 55% (in analogous manner to DIN 53512, April 2000; the departure from the standard is the test specimen height, which should be 12 mm, but this test is carried out with 20 mm in order to avoid collapse of the sample and measurement of the substrate).

As stated above, there is a relationship between the density and the compression properties of the molded articles produced. The density of the molded articles produced is advantageously from 75 to 375 kg/m³, preferably from 100 to 300 kg/m³, more preferably from 150 to 200 kg/m³ (DIN EN ISO 845, October 2009).

The ratio of the density of the molded article to the bulk density of the foamed pellets of the invention is generally between 1.5 and 2.5, preferably 1.8 to 2.0.

The invention additionally provides for the use of a foamed pellet material of the invention for the production of a molded article for shoe intermediate soles, shoe insoles, shoe combination soles, bicycle saddles, bicycle tires, damping elements, cushioning, padding, backrests, arm pads, pads, mattresses, underlays, handles, protective films, in components in the automotive interior and exterior sector, in balls and sports equipment or as floor covering, in particular for sports surfaces, track and field surfaces, sports halls, children's playgrounds and walkways.

Preference is given to using a foamed pellet material of the invention for the production of a molded article for shoe intermediate soles, shoe insoles, shoe combination soles or a cushioning element for shoes.

The shoe is here preferably an outdoor shoe, sports shoe, sandals, boot or safety shoe, more preferably a sports shoe.

The present invention accordingly further also provides a molded article, wherein the molded article is a shoe combination sole for shoes, preferably for outdoor shoes, sports shoes, sandals, boots or safety shoes, more preferably sports shoes.

The present invention accordingly further also provides a molded article, wherein the molded article is an intermediate sole for shoes, preferably for outdoor shoes, sports shoes, sandals, boots or safety shoes, more preferably sports shoes.

The present invention accordingly further also provides a molded article, wherein the molded article is an insole for shoes, preferably for outdoor shoes, sports shoes, sandals, boots or safety shoes, more preferably sports shoes,

The present invention accordingly further also provides a molded article, wherein the molded article is a cushioning, element for shoes, preferably for outdoor shoes, sports shoes, sandals, boots or safety shoes, more preferably sports shoes.

The cushioning element can here be used for example in the heel region or forefoot region.

The present invention therefore also further provides a shoe in which the molded article of the invention is used as midsole, intermediate sole or cushioning in, for example, the heel region or forefoot region, wherein the shoe is preferably an outdoor shoe, sports shoe, sandal, boot or safety shoe, particularly preferably a sports shoe.

In a further aspect, the present invention also relates to a foamed pellet material obtained or obtainable by a process of the invention.

Their good mechanical properties and good temperature behavior make the foamed pellets of the invention particularly suitable for the production of molded articles. Molded articles can for example be produced from the foamed pellets of the invention by fusion or bonding.

In a further aspect, the present invention also relates to the use of a foamed pellet material of the invention or of a foamed pellet material obtained or obtainable by a process of the invention for the production of molded articles. In a further embodiment, the present invention accordingly also relates to the use of a foamed pellet material of the invention, or of a foamed pellet material obtained or obtainable by a process of the invention, for the production of molded articles, wherein the molded article is produced by fusing or bonding of the beads to one another.

The molded articles obtained in accordance with the invention are suitable, for example, for the production of footwear soles, parts of a footwear sole, bicycle saddles, cushioning, mattresses, underlays, grips, protective films, components in automobile interiors and exteriors, in balls and sports equipment or as floor covering and wall paneling, especially for sports surfaces, track and field surfaces, sports halls, children's playgrounds, and pathways.

In a further embodiment, the present invention accordingly also relates to the use of a foamed pellet material of the invention or of a foamed pellet material obtained or obtainable by a process of the invention for the production of molded articles, wherein the molded article is a shoe sole, part of a shoe sole, a bicycle saddle, cushioning, a mattress, underlay, grip, protective film, a component in automobile interiors and exteriors.

In a further aspect, the present invention also relates to the use of the foamed pellets or foamed beads of the invention in balls and sports equipment or as floor covering and wall paneling, especially for sports surfaces, track and field surfaces, sports halls, children's playgrounds, and pathways.

In a further aspect, the present invention also relates to a hybrid material comprising a matrix composed of a polymer (PM) and a foamed pellet material according to the present invention. Materials comprising a foamed pellet material and a matrix material are in the context of this invention referred to as hybrid materials. The matrix material here may be composed of a compact material or likewise of a foam.

Polymers (PM) suitable as matrix material are known per se to those skilled in the art. Suitable in the context of the present invention are for example ethylene-vinyl acetate copolymers, epoxy-based binders or else polyurethanes. Polyurethane foams or else compact polyurethanes, for example resilient polyurethanes, are suitable here in accordance with the invention.

The chosen polymer (PM) is according to the invention one that provides sufficient adhesion between the foamed pellets and the matrix such that a mechanically stable hybrid material is obtained.

The matrix here may completely or partly surround the foamed pellet material. The hybrid material may according to the invention comprise further components, for example further fillers or else pellets. The hybrid material may according to the invention also comprise mixtures of different polymers (PM). The hybrid material may also comprise mixtures of foamed pellets.

Foamed pellets that may be used in addition to the foamed pellet material according to the present invention are known per se to those skilled in the art. Foamed pellets composed of thermoplastic polyurethanes are particularly suitable in the context of the present invention.

In one embodiment, the present invention accordingly also relates to a hybrid material comprising a matrix composed of a polymer (PM), a foamed pellet material according to the present invention and a further foamed pellet material composed of a thermoplastic polyurethane.

The matrix consists in the context of the present invention of a polymer (PM). Examples of matrix materials suitable in the context of the present invention are elastomers or foams. in particular foams based on polyurethanes, for example elastomers such as ethylene-vinyl acetate copolymers or else thermoplastic polyurethanes.

The present invention accordingly also relates to a hybrid material as described above, wherein the polymer (PM) is an elastomer. The present invention further relates to a hybrid material as described above, wherein the polymer (PM) is selected from the group consisting of ethylene-vinyl acetate copolymers and thermoplastic or resilient polyurethanes.

In one embodiment, the present invention also relates to a hybrid material comprising a matrix composed of an ethylene-vinyl acetate copolymer and a foamed pellet material according to the present invention.

In a further embodiment, the present invention relates to a hybrid material comprising, a matrix composed of an ethylene-vinyl acetate copolymer, a foamed pellet material according to the present invention and a further foamed pellet material composed for example of a thermoplastic polyurethane.

In one embodiment, the present invention relates to a hybrid material comprising a matrix composed of a resilient polyurethane and a foamed pellet material according to the present invention.

In a further embodiment, the present invention relates to a hybrid material comprising a matrix composed of a thermoplastic or resilient polyurethane, a foamed pellet material of the present invention, and a further foamed pellet material composed for example of a thermoplastic polyurethane.

Suitable thermoplastic and resilient polyurethanes are known per se to those skilled in the art. Suitable polyurethanes are described for example in “Kunststoffhandbuch” [Plastics handbook], volume 7, “Polyurethane” [Polyurethanes], Carl Hanser Verlag, 3rd edition 1993, chapter 3.

The polymer (PM) is in the context of the present invention preferably a polyurethane. “Polyurethane” for the purposes of the invention encompasses all known resilient polyisocyanate polyaddition products. These include, in particular, solid polyisocyanate polyaddition products, such as viscoelastic gels or thermoplastic polyurethanes, and resilient foams based on polyisocyanate polyaddition products, such as flexible foams, semirigid foams or integral foams. For the purposes of the invention, “polyurethanes” are also understood as meaning resilient polymer blends comprising polyurethanes and further polymers, and also foams composed of these polymer blends. The matrix is preferably a hardened, compact polyurethane binder, a resilient polyurethane foam or a viscoelastic gel.

A “polyurethane binder” is in the context of the present invention understood as meaning a mixture that consists to an extent of at least 50% by weight, preferably to an extent of at least 80% by weight, and in particular to an extent of at least 95% by weight, of a prepolymer having isocyanate groups, referred to hereinafter as isocyanate prepolymer. The viscosity of the polyurethane binder of the invention is preferably within a range from 500 to 4000 mPa·s, more preferably from 1000 to 3000 mPa·s, measured at 25° C. in accordance with DIN 53 018.

In the context of the invention “polyurethane foams” are to be understood as meaning foams in accordance with DIN 7726.

The density of the matrix material is preferably within a range from 1.2 to 0.01 g/cm³. The matrix material is particularly preferably a resilient foam or an integral foam having a density within a range from 0.8 to 0.1 g/cm³, especially from 0.6 to 0.3 g/cm³, or a compact material, for example a hardened polyurethane binder.

Foams are particularly suitable as matrix materials. Hybrid materials comprising a matrix material composed of a polyurethane foam preferably have good adhesion between the matrix material and foamed pellet material.

In one embodiment, the present invention also relates to a hybrid material comprising a matrix composed of a polyurethane foam and a foamed pellet material according to the present invention.

In a further embodiment, the present invention relates to a hybrid material comprising a matrix composed of a polyurethane foam, a foamed pellet material according to the present invention and a further foamed pellet material composed for example of a thermoplastic polyurethane.

In one embodiment, the present invention relates to a hybrid material comprising a matrix composed of a polyurethane integral foam and a foamed pellet material according to the present invention.

In a further embodiment, the present invention relates to a hybrid material comprising a matrix composed of a polyurethane integral foam, a foamed pellet material according to the present invention, and a further foamed pellet material composed for example of a thermoplastic polyurethane.

A hybrid material of the invention comprising a polymer (PM) as matrix and a foamed pellet material of the invention can for example be produced by mixing the components used to produce the polymer (PM) and the foamed pellet material optionally with further components, and reacting them to give the hybrid material, the reaction preferably being carried out under conditions at which the foamed pellet material is essentially stable.

Suitable processes and reaction conditions for producing the polymer (PM), especially an ethylene-vinyl acetate copolymer or a polyurethane, are known per se to those skilled in the art.

In a preferred embodiment, the hybrid materials of the invention are integral foams, especially integral foams based on polyurethanes. Suitable processes for producing integral foams are known per se to those skilled in the art. The integral foams are preferably produced by the one-shot process using the low-pressure or high-pressure technique in closed, advantageously temperature-controlled molds. The molds are usually made of metal, for example aluminum or steel. These procedures are described for example by Piechota and Röhr in “Integralschaumstoff” [Integral foam], Carl-Hanser-Verlag, Munich, Vienna, 1975, or in “Kunststoff-Handbuch” [Plastics handbook], volume 7. “Polyurethane” [Polyurethanes], 3rd edition, 1993, chapter 7.

If the hybrid material of the invention comprises an integral foam, the amount of the reaction mixture introduced into the mold is such that the resulting molded articles composed of integral foams have a density of 0.08 to 0,70 g/cm³, in particular of 0.12 to 0.60 g/cm³. The densification levels for the production of the molded articles having a compacted edge zone and cellular core are within a range from 1.1 to 8.5, preferably from 2.1 to 7.0.

It is thus possible to produce hybrid materials having a matrix composed of a polymer (PM) and incorporating the foamed pellet material of the invention, in which there is a homogeneous distribution of the foamed beads. The foamed pellet material of the invention can readily be used in a process for producing a hybrid material since the individual beads are free-flowing on account of their small size and do not place any specific demands on processing. It is possible here to use techniques for homogeneously distributing the foamed pellet material, such as slow rotation of the mold.

Further auxiliaries and/or additives may optionally also be added to the reaction mixture for producing the hybrid materials of the invention. Examples include surface-active substances, foam stabilizers, cell regulators, release agents, fillers, dyes, pigments, hydrolysis stabilizers, odor-absorbing substances and fungistatic and bacteriostatic substances.

Surface-active substances that may be used are e.g. compounds used to promote homogenization of the starting materials and that optionally are also suitable for regulating the cell structure. Examples include emulsifiers, for example the sodium salts of castor oil sulfates or of fatty acids and also salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid; foam stabilizers, for example siloxane-oxyalkylene copolymers and other organopolysiloxanes, ethoxylated alkylphenols, ethoxylated fatty alcohols, paraffin oils, castor oil esters or ricinoleic esters, Turkey red oil, and peanut oil, and cell regulators, for example paraffins, fatty alcohols, and dimethylpolysiloxanes. Oligomeric acrylates having polyoxyalkylene and fluoroalkane radicals as pendant groups are also suitable for improving the emulsifying action, cell structure and/or stabilization of the foam.

Examples of suitable release agents include: reaction products of tatty acid esters with polyisocyanates, salts of amino group-containing polysiloxanes and fatty acids, salts of saturated or unsaturated (cyclo)aliphatic carboxylic acids having at least 8 carbon atoms and tertiary amines, and also especially internal release agents, such as carboxylic: esters and/or carboxylic amides produced by esterification or amidation of a mixture of montanic acid and at least one aliphatic carboxylic acid having at least 10 carbon atoms with at least difunctional alkanolamines, polyols and/or polyamines having molecular weights of 60 to 400, mixtures of organic amines, metal salts of stearic acid and organic mono- and/or dicarboxylic acids or anhydrides thereof or mixtures of an imino compound, the metal salt of a carboxylic acid, and optionally a carboxylic acid.

Fillers, in particular reinforcing fillers, are understood as meaning the customary organic and inorganic fillers, reinforcers, weighting agents, agents for improving abrasion behavior in paints, coating compositions etc. that are known per se. Specific examples include: inorganic fillers such as siliceous minerals, for example phyllosilicates such as antigorite, bentonite, serpentine, hornblendes, amphiboles, chrysotile, talc; metal oxides such as kaolin, aluminum oxides, titanium oxides, zinc oxide, and iron oxides, metal salts such as chalk, barite and inorganic pigments such as cadmium sulfide, zinc sulfide and also glass and the like. Preference is given to using kaolin (china clay), aluminum silicate and coprecipitates of barium sulfate and aluminum silicate and also natural and synthetic fibrous minerals such as wollastonite, metal fibers, and in particular glass fibers of varying length, which may optionally have been sized. Examples of useful organic fillers include: carbon black, melamine, rosin, cyclopentadienyl resins and graft polymers, and also cellulose fibers, polyamide fibers, polyacrylonitrile fibers, polyurethane fibers, polyester fibers based on aromatic and/or aliphatic dicarboxylic esters, and in particular carbon fibers.

The inorganic and organic fillers may be used individually or as mixtures.

In a hybrid material of the invention, the proportion by volume of the foamed pellet material is preferably 20 percent by volume or more, particularly preferably 50 percent by volume and more preferably 80 percent by volume or more and in particular 90 percent by volume or more, based in each case on the volume of the hybrid system of the invention.

The hybrid materials of the invention, especially hybrid materials having a matrix composed of cellular polyurethane, feature very good adhesion of the matrix material to the foamed pellet material of the invention. As a result, there is preferably no tearing of a hybrid material of the invention at the interface of the matrix material and foamed pellet material. This makes it possible to produce hybrid materials in which mechanical properties such as tear-propagation resistance and elasticity are improved compared to conventional polymer materials, especially conventional polyurethane materials, of the same density.

The elasticity of hybrid materials of the invention in the form of integral foams is preferably greater than 40% and more preferably greater than 50% in accordance with DIN 53512.

Moreover, the hybrid materials of the invention, especially those based on integral foams, have high resiliences at low density. Particularly integral foams based on hybrid materials of the invention are therefore outstandingly suitable as materials for shoe soles. Light and comfortable soles with good durability properties are thereby obtained. Such materials are especially suitable as intermediate soles for sports shoes.

The hybrid materials of the invention having a cellular matrix are suitable, e.g. for cushioning, for example in furniture, and mattresses.

A particular feature of hybrid materials having a matrix composed of a viscoelastic gel is increased viscoelasticity and improved elastic properties. These materials are thus likewise suitable as cushioning materials, for example for seats, especially saddles such as bicycle saddles or motorcycle saddles.

Hybrid materials having a compact matrix are suitable e.g. as floor coverings, especially as covering for playgrounds, track and field surfaces, sports fields and sports halls.

The properties of the hybrid materials of the invention may vary within wide ranges depending on the polymer (PM) used, and can be varied within wide limits in particular by varying the size, shape and nature of the expanded pellet material or else by adding further additives, for example by also adding further non-foamed pellets such as plastics pellets, for example rubber pellets.

The hybrid materials of the invention have high durability and toughness, which is evidenced in particular by high tensile strength and elongation at break. In addition, hybrid materials of the invention have a low density.

Further embodiments of the present invention can be found in the claims and the examples. It is understood that the features of the subject matter/processes/uses according, to the invention recited above and elucidated below may be used not only in the combination specified in each case but also in other combinations without departing from the scope of the invention. Thus, for example, the combination of a preferred feature with a particularly preferred feature or of a feature not characterized further with a particularly preferred feature etc. is also encompassed implicitly even if this combination is not mentioned explicitly.

Exemplary embodiments of the present invention are recited hereinbelow but are not intended to limit the present invention. In particular, the present invention also encompasses those embodiments that result from the dependency references and thus combinations specified hereinbelow:
1. A foamed pellet material comprising a composition (Z1) that comprises a thermoplastic polyurethane (TPU-1) and at least one plasticizer (W), the composition (71) having a Shore hardness within a range from 15 A to 43 A.
2. The foamed pellet material according to claim 1, wherein the composition (Z1) has a Shore hardness within a range from 15 A to 43 A.
3. The foamed pellet material according to claim 1 or 2, wherein the melting range of the composition (Z1) begins below 100° C. in a DSC measurement with a heating rate of 20 K/min and in which the composition (Z1) at 180° C. and an applied weight of 21.6 kg in accordance with DIN EN ISO 1133 has a maximum melt flow rate (MFR) of 250 g/10 min.
4. The foamed pellet material according to any of claims 1 to 3, wherein the plasticizer (W) is selected from derivatives of citric acid and of glycerol or mixtures of two or more thereof, wherein at least one glycerol hydroxyl group has been esterified with a monocarboxylic acid having 1, 2, 3, 4, 5 or 6 carbon atoms.
5. The foamed pellet material according to any of claims 1 to 4, wherein the plasticizer (W) is present in the composition (Z1) in an amount within a range from 1% to 60% by weight based on the total composition (Z1).
6. The foamed pellet material according to any of claims 1 to 5, wherein the composition (Z1) comprises an ester of a tricarboxylic acid as a plasticizer (W2).
7. The foamed pellet material according to any of claims 1 to 6, wherein the thermoplastic polyurethane (TPU-1) is produced using a polyol (P1) selected from the group consisting of polyetherols, polyesterols, polycarbonate alcohols, and hybrid polyols.
8. The foamed pellet material according to any of claims 1 to 7, wherein the thermoplastic polyurethane (TPU-1) is produced using a chain extender (KV) selected from the group consisting, of 1,2-ethylene glycol, propane-1,3-diol, butane-1,4-diol, and hexane-1,6-diol.
9. The foamed pellet material according, to any of claims 1 to 8, wherein the thermoplastic polyurethane (TPU-1) is produced using a diisocyanate selected from the group consisting of diphenylmethane 2,2′-, 2,4′- and/or 4,4′-diisocyanate (MDI), tolylene 2,4- and/or 2,6-diisocyanate (TDI), methylenedicyclohexyl 4,4′-, 2,4′- and/or 2,2′-diisocyanate (H12MDI), hexamethylene diisocyanate (HDI), and 1-isocyanato-3,3,5-trimethyl-5-isocyanatomethylcyclohexane (IPDI).
10. A process for producing a foamed pellet material, comprising the steps of
   (i) providing, a composition (Z1) that comprises a thermoplastic polyurethane (TPU-1) and at least one plasticizer (W), the composition (Z1) having a Shore hardness within a range from 15 A to 43 A;
   (ii) impregnating the composition (Z1) with a blowing agent under pressure;
   (iii) expanding the composition (Z1) by means of a pressure drop.
11. A process for producing, a foamed pellet material, comprising the steps of
   (i′) extruding a composition (Z1) that comprises a thermoplastic polyurethane (TPU-1) and at least one plasticizer (W), the composition (Z1) having a Shore hardness within a range from 15 A to 43 A, to obtain a pellet material having an average diameter within a range from 0.2 to 10 mm;
   (ii′) impregnating the pellet material under pressure with 0.1% to 40% by weight of a blowing agent, based on the total weight of the pellet material, and then
   (iii′) depressurizing to obtain a foamed pellet material.
12. The process according to claim 10 or 11, wherein the blowing agent is selected from the group consisting of butane, propane, pentane, carbon dioxide, and nitrogen.
13. The process according to any of embodiments 10 to 12, wherein the composition (Z1) has a Shore hardness within a range from 15 A to 43 A.
14. The process according to any of embodiments 10 to 13, wherein the melting range of the composition (Z1) begins below 100° C. in a DSC measurement with a heating rate of 20 K/min and in which the composition (Z1) at 180° C. and an applied weight of 21.6 kg in accordance with DIN EN ISO 1133 has a maximum melt flow rate (MFR) of 250 g/10 min.
15. The process according to any of embodiments 10 to 14, wherein the plasticizer (W) is selected from derivatives of citric acid and of glycerol or mixtures of two or more thereof, wherein at least one glycerol hydroxyl group has been esterified with a monocarboxylic acid having 1, 2, 3, 4, 5 or 6 carbon atoms.
16. The process according to any of embodiments 10 to 15, wherein the plasticizer (W) is present in the composition (Z1) in an amount within a range from 1% to 60% by weight based on the total composition (Z1).
17. The process according to any of embodiments 10 to 16, wherein the composition (Z1) comprises an ester of a tricarboxylic acid as a plasticizer (W2).
18. The process according to any of embodiments 10 to 17, wherein the thermoplastic polyurethane (TPU-1) is produced using a polyol (P1) selected from the group consisting of polyetherols, polyesterols, polycarbonate alcohols, and hybrid polyols.
19. The process according to any of embodiments 10 to 18, wherein the thermoplastic polyurethane (TPU-1) is produced using a chain extender (KV) selected from the group consisting of 1,2-ethylene glycol, propane-1,3-diol, butane-1,4-diol, and hexane-1,6-diol.
20. The process according to any of embodiments 10 to 19, wherein the thermoplastic polyurethane (TPU-1) is produced using a diisocyanate selected from the group consisting of diphenylmethane 2,2′-, 2,4′- and/or 4,4′-diisocyanate (MDI), tolylene 2,4- and/or 2,6-diisocyanate (TDI), methylenedicyclohexyl 4,4′-, 2,4′- and/or 2,2′-diisocyanate (H12MDI), hexamethylene diisocyanate (TDI), and 1-isocyanato-3,3,5-trimethyl-5-isocyanatomethylcyclohexane (IPDI).
21. A foamed pellet material obtained or obtainable by a process according to any of embodiments 10 to 20.
22. The use of a foamed pellet material according to any of embodiments 1 to 9 or 21 for the production of a molded article.
23. The use according to embodiment 22, wherein the molded article is produced by fusing or bonding of the beads of the foamed pellet material to one another.
24. The use according to embodiment 22 or 23, wherein the molded article is a shoe sole, part of a shoe sole, a bicycle saddle, cushioning, a mattress, padding, backrests, arm pads, pads, underlay, handles, protective film, a component in automobile interiors and exteriors.
25. The use of foamed beads according to any of embodiments 1 to 9 or 21 in bails and sports equipment or as floor covering, and wall paneling, especially for sports surfaces, track and field surfaces, sports halls, children's playgrounds, and pathways.
26. A hybrid material comprising, a matrix composed of a polymer (PM) and a foamed pellet material according to any of embodiments 1 to 9 or 21 or a foamed pellet material obtainable or obtained by a process according to any of embodiments 10 to 20.
27. The hybrid material according to embodiment 26, wherein the polymer (PM) is an EVA.
28, The hybrid material according to embodiment 26, wherein the polymer (PM) is a thermoplastic polyurethane.
29. The hybrid material according to embodiment 26, wherein the polymer (PM) is a resilient polyurethane.
30. The hybrid material according to embodiment 26, wherein the polymer (PM) is a polyurethane foam.
31. The hybrid material according to embodiment 26, wherein the polymer (PM) is a polyurethane integral foam.

The examples that follow serve to illustrate the invention, but are in no way limiting in respect of the subject matter of the present invention.

### EXAMPLES

1. The Following Feedstocks Were Used:
4,4′-Diphenylmethane diisocyanate
Polytetrahydrofuran having a number-average molar mass of 1 kg/mol
Polybutyl adipate having a number-average molar mass of 2400 g/mol produced from butane-1,4-diol and adipic acid
Polymer diols produced from adipic acid, ethane 2-diol, butane-1,4-diol
Butane-1,4-diol
Ethane-1,2-diol
Phenolic antioxidant
Dioctyl adipate
Tin dioctoate
Hydrolysis stabilizers (oligomeric carbodiimide produced from TMDXI=tetramethylxylyl diisocyanate)
Acetyl tributyl citrate

2. Production of TPU Pellets

### 2.1 Example 1 (Comparison)

420 parts of 4,4′-diphenylmethane diisocyanate, 88.8 parts of butane-1,4-diol chain extender, and 700 parts of polytetrahydrofuran having a number-average molar mass of 1 kg/mol are synthesized into TPU in a reaction extruder, the zone temperatures of the extruder being between 140° C. and 21.0° C. In addition, 15.3 parts of a phenolic antioxidant and 25 ppm of a 25% dioctyl adipate solution of tin dioctoate are added as reaction catalyst. The pelletized TPU thus produced is used to produce extrusion strands, on which the test values are determined.

### 2.2 Example 2 (Comparison)

312 parts of 4,4′-diphenylmethane diisocyanate, 82.1 parts of butane-1,4-diol chain extender, and 800 parts of polybutyl adipate having a number-average molar mass of 2400 g/mol produced from butane-1,4-diol and adipic acid are synthesized into TPU in a manual casting process. In addition, 6.4 parts of a hydrolysis stabilizer (oligorneric carbodiimide produced from TMDXI=tetramethylxylyl diisocyanate) and 50 ppm of a 25% solution of tin dioctoate are added as reaction catalyst. The slab obtained is heated for 15 hours at 80° C. in an air-circulation oven and then comminuted. The pelletized TPU thus produced is used to produce extrusion strands, on which the test values are determined.

### 2.3 Example 3 (Inventive)

393 parts of 4,4′-diphenylmethane diisocyanate, 35.5 parts of ethane-1,2-diol chain extender, and 1000 parts of polytetrahydrofuran having a number-average molar mass of 1 kg/mol and 410 parts of acetyl tributyl citrate are synthesized into TPU in a reaction extruder, the zone temperatures of the extruder being between 140° C. and 210° C. In addition, 15.3 parts of a phenolic antioxidant and 25 ppm of a 25% dioctyl adipate solution of tin dioctoate are added as reaction catalyst. The pelletized TPU thus produced is used to produce extrusion strands, on which the test values are determined.

### 2.4 Example 4 (Inventive)

260 parts of 4,4-MDI, 32.2 parts of ethane-1,2-diol chain extender, and 1000 parts of a polymer diol produced from adipic acid, ethane-1,2-diol, and butane-1,4-diol, the latter in a mass ratio of 1:1, having a number-average molar mass of 2000 g/mol, and 231.2 parts of acetyl tributyl citrate are synthesized into TPU in a reaction extruder, the zone temperatures of the extruder being between 140° C. and 210° C. In addition, 10 parts of a hydrolysis stabilizer (oligomeric carbodiimide produced from TMDXI=tetramethylxylyl diisocyanate), 3.08 parts of a phenolic: antioxidant, and 4.62 parts of a lubricant (partly hydrolyzed montan acid esters) are added during, the reaction. The pelletized TPU thus produced is used to produce extrusion strands, on which the test values are determined.

### 2.5 Example 5 (Inventive)

260 parts of 4,4′-MDI, 31.6 parts of ethane-1,2-diol chain extender, and 1000 parts of a polymer diol produced from adipic acid, ethane-1,2-diol, and butane-1,4-diol, the latter in a mass ratio of 1:1, having a number-average molar mass of 2000 g/mol, and 260 parts of acetyl tributyl citrate are synthesized into TPU in a reaction extruder, the zone temperatures of the extruder being between 140° C. and 210° C. In addition, 10 parts of a hydrolysis stabilizer (oligomeric carbodiimide produced from tetramethylxylyl diisocyanate), 3.08 parts of a phenolic antioxidant, and 4.62 parts of a lubricant (partly hydrolyzed montan acid esters) are added during the reaction. The pelletized TPU thus produced is used to produce extrusion strands, on which the test values are determined.

### 2.6 Example 6 (Inventive)

260 parts of 4,4′-MDI, 32.2 parts of ethane-1,2-diol chain extender, and 1000 parts of a polymer diol produced from adipic acid, ethane-1,2-diol, and butane-1,4-diol, the latter in a mass ratio of 1:1, having a number-average molar mass of 2000 g/mol, and 231.2 parts of acetyl tributyl citrate are synthesized into TPU in a reaction extruder, the zone temperatures of the extruder being between 140° C. and 210° C. In addition, 10 parts of a hydrolysis stabilizer (oligomeric carbodiimide produced from TMDXI=tetramethylxylyl diisocyanate), 3.08 parts of a phenolic antioxidant, and 4.62 parts of a lubricant (partly hydrolyzed montan acid esters) are added during the reaction. The pelletized TPU thus produced is used to produce extrusion strands, on which the test values are determined. The product obtained is heated to 85° C. in a heatable mixer (DiOsa type) and mixed with 25% by weight of glycerol triacetate. After a mixing step of 90 minutes, the product is cooled to room temperature while stirring. The plasticizer is absorbed homogeneously by the TPU. The pelletized TPU thus produced is used to produce extrusion strands, on which the test values are determined.

### 2.7 Example 7 (Inventive)

260 parts of 4,4′-MDI, 32.2 parts of ethane-1,2-diol chain extender, and 1000 parts of a polymer diol produced from adipic acid, ethane-1,2-diol, and butane-1,4-diol, the latter in a mass ratio of 1:1, having a number-average molar mass of 2000 g/mol, and 231.2 parts of acetyl tributyl citrate are synthesized into TPU in a reaction extruder, the zone temperatures of the extruder being between 140° C. and 210° C. In addition, 10 parts of a hydrolysis stabilizer (oligomeric carbodiimide produced from TMDXI=tetramethylxylyl diisocyanate), 3.08 parts of a phenolic antioxidant, and 4.62 parts of a lubricant (partly hydrolyzed montan acid esters) are added during the reaction. The pelletized TPU thus produced is used to produce extrusion strands, on which the test values are determined. The product is heated to 85° C. in a heatable mixer (DiOsa type) and mixed with 45% by weight of glycerol triacetate. After a mixing step of 180 minutes, the product is cooled to room temperature while stirring. The plasticizer is absorbed homogeneously by the TPU. The pelletized TPU thus produced is used to produce extrusion strands, on which the test values are determined.

3. Properties of the Products Obtained

The tests are carried out in accordance with DIN 53505 (Shore)

TABLE 1

| | Shore | | Tensile | Elongation |
|---|---|---|---|---|
| | hardness | Density | strength | at break |
| | DIN ISO | [g/l] | [MPa] | [%] |
| | 7619-1 | DIN | DIN | DIN |
| Examples | (3s) | 53504-S2 | 53504-S2 | 53504-S2 |
| 1 (comparative) | 86 A | 1.12 | 43 | 600 |
| 2 (comparative) | 95 A | 1.21 | 48 | 520 |
| 3 | 42 A | 1.08 | 15 | 1100 |
| 4 | 37 A | 1.18 | 12 | 1150 |
| 5 | 43 A | 1.18 | 27 | 950 |
| 6 | 35 A | 1.19 | 12 | 1200 |
| 7 | 29 A | 1.19 | 10 | 1350 |

4. Production of Bead Foams

Pelletized TPU samples (examples 1-7) were pressurized with supercritical CO₂ in a high-pressure autoclave in accordance with Table 2, resulting in penetration of CO₂ into the TPU. (he beads were then subjected to a pressure change. During, this pressure change, the CO₂, which had previously been under high pressure, expanded to standard pressure and in this process foamed the partially softened TPU. The sudden cooling caused by the gas expansion resulted in the TPU solidifying into a stable bead foam.

TABLE 2

| | | | Depres- | |
|---|---|---|---|---|
| | Autoclave | Autoclave | surization | Impregnation |
| | temperature | pressure | pressure | time |
| Examples | [° C.] | [bar] | [bar] | [hours] |
| 1 (comparative) | 120 | 135 | 1 | 4 |
| 2 (comparative) | 120 | 135 | 1 | 4 |
| 3 | 120 | 135 | 1 | 4 |
| 4 | 120 | 135 | 1 | 4 |
| 5 | 120 | 135 | 1 | 4 |
| 6 | 120 | 135 | 1 | 4 |
| 7 | 120 | 135 | 1 | 4 |
| 3 | 120 | 200 | 1 | 3 |
| 4 | 120 | 200 | 1 | 3 |
| 5 | 120 | 200 | 1 | 3 |
| 6 | 120 | 200 | 1 | 3 |
| 7 | 120 | 200 | 1 | 3 |
| 3 | 130 | 200 | 1 | 3 |
| 4 | 130 | 200 | 1 | 3 |
| 5 | 130 | 200 | 1 | 3 |
| 6 | 130 | 200 | 1 | 3 |
| 7 | 130 | 200 | 1 | 3 |

TABLE 3

| | Autoclave | Autoclave | | |
|---|---|---|---|---|
| | temperature | pressure | | Density |
| Examples | [° C.] | [bar] | Appearance | [g/l] |
| 1 (comparative) | 120 | 135 | minimally foamed | 425 |
| 2 (comparative) | 120 | 135 | minimally foamed | 550 |
| 3 | 120 | 135 | well foamed | 265 |
| 4 | 120 | 135 | well foamed, | 213 |
| | | | rough | |
| 5 | 120 | 135 | foamed | 370 |
| 6 | 120 | 135 | well foamed | 255 |
| 7 | 120 | 135 | well foamed | 238 |
| 3 | 120 | 200 | well foamed | 252 |
| 4 | 120 | 200 | well foamed, | 217 |
| | | | rough | |
| 5 | 120 | 200 | foamed | 324 |
| 6 | 120 | 200 | well foamed | 250 |
| 7 | 120 | 200 | well foamed, | 232 |
| | | | nonspherical | |
| 3 | 130 | 200 | well foamed | 260 |
| 4 | 130 | 200 | well foamed | 220 |
| 5 | 130 | 200 | well foamed | 308 |
| 6 | 130 | 200 | well foamed | 248 |
| 7 | 130 | 200 | well foamed, | 238 |
| | | | nonspherical | |

5. Measurement Methods:

Measurement methods that can be used for the material characterization include the following: DSC, DMA, IMA, NMR, FT-IR, GPC

| Mechanical properties | (eTPU) |
|---|---|
| Foam density | DIN EN ISO 845: 2009-10 |
| Tear-propagation resistance | DIN EN ISO 8067: 2009-06 |
| Dimensional stability test | ISO 2796: 1986-08 |
| Tensile test | ASTM D5035: 2011 |
| Resilience | DIN 53512: 2000-4 |

### CITED LITERATURE

WO 94/20568

WO 2007/082838 A1

WO 2017/030835

WO 2013/153190 A1

WO 2010/010010

WO 2011/141408 A2

“Kunststoffhandbuch” [Plastics handbook], volume 7, “Polyurethane” [Polyurethanes], Carl Hansel Verlag, 3rd edition, 1993, chapter 3.1.

Plastics Additive Handbook, 5th edition, H. Zweifel, ed Hanser Publishers, Munich, 2001 ([1]), pages 98-136

Saechtling (ed.), Kunststoff-Taschenbuch [Plastics handbook], 27th edition, Hanser-Verlag, Munich, 1998, chapters 3.2.1 and 3.2.4

EP 1979401 B1

US 2015/0337102

EP 2872309

EP 3053732 A

WO 2016/146537

“Kunststoffhandbuch” [Plastics handbook], volume 7, “Polyurethane” [Polyurethanes], Carl Hanser Verlag, 3rd edition, 1993, chapter 3

Piechota and Röhr in “Integralschaumstoff” [Integral foam], Carl-Hanser-Verlag, Munich, Vienna, 1975

“Kunststoff-Handbuch” [Plastics handbook], volume 7, “Polyurethane” [Polyurethanes], 3rd edition, 1993, chapter 7

1. A foamed pellet material comprising a composition (Z1) that comprises a thermoplastic polyurethane (TPU-1) and at least one plasticizer (W), the composition (Z1) having a Shore hardness within a range from 15 A to 43 A.

2. (canceled)

3. The foamed pellet material according to claim 1, wherein a melting range of the composition (Z1) begins below 100° C. in a DSC measurement with a heating rate of 20 K/min and in which the composition (Z1) at 180° C. and an applied weight of 21.6 kg in accordance with DIN EN ISO 1133 has a maximum melt flow rate (MFR) of 250 g/10 min.

4. The foamed pellet material according to claim 1, wherein the at least one plasticizer (W) is selected from the group consisting of a derivative of citric acid, a derivative of glycerol, and a mixture of two or more thereof,
wherein the derivative of glycerol, if present, has at least one glycerol hydroxyl group which has been esterified with a monocarboxylic acid having 1, 2, 3, 4, 5, or 6 carbon atoms.

5. The foamed pellet material according to claim 1, wherein the at least one plasticizer (W) is present in the composition (Z1) in an amount within a range from 1% to 60% by weight, based on the total composition (Z1).

6. The foamed pellet material according to claim 1, wherein the composition (Z1) comprises the at least one plasticizer (W), and
wherein the composition (Z1) comprises an ester of a tricarboxylic acid as a plasticizer (W2).

7. The foamed pellet material according to claim 1, wherein the thermoplastic polyurethane (TPU-1) is produced using a polyol (P1) selected from the group consisting of polyetherols, polyesterols, polycarbonate alcohols, and hybrid polyols.

8. The foamed pellet material according to claim 1, wherein the thermoplastic polyurethane (TPU-1) is produced using a chain extender (KV) selected from the group consisting of 1,2-ethylene glycol, propane-1,3-diol, butane-1,4-diol, and hexane-1,6-diol.

9. The foamed pellet material according to claim 1, wherein the thermoplastic polyurethane (TPU-1) is produced using a diisocyanate selected from the group consisting of diphenylmethane 2,2′-, and 4,4′-diisocyanate (MDI); tolylene 2,4- and 2,6-diisocyanate (TDI); methylenedicyclohexyl 4,4′-, and 2,2′-diisocyanate (H12MDI); hexamethylene diisocyanate (HDI); and 1-isocyanato-3,3,5-trimethyl-5-isocyanatomethylcyclohexane (IPDI).

10. A process for producing a foamed pellet material, comprising:
(i) providing a composition (Z1) that comprises a thermoplastic polyurethane (TPU-1) and at least one plasticizer (W), the composition (Z1) having a Shore hardness within a range from 15 A to 43 A;
(ii) impregnating the composition (Z1) with a blowing agent under pressure; and
(iii) expanding the composition (Z1) by means of a pressure drop.

11. A process for producing a foamed pellet material, comprising:
(i′) extruding a composition (Z1) that comprises a thermoplastic polyurethane (TPU-1) and at least one plasticizer (W), the composition (Z1) having a Shore hardness within a range from 15 A to 43 A, to obtain a pellet material having an average diameter within a range from 0.2 to 10 mm;
(ii′) impregnating the pellet material under pressure with 0.1% to 40% by weight of a blowing agent, based on a total weight of the pellet material, and
(iii′) depressurizing to obtain a foamed pellet material.

12. The process according to claim 10, wherein the blowing agent is selected from the group consisting of butane, propane, pentane, carbon dioxide, and nitrogen.

13. A foamed pellet material obtained or obtainable by the process according to claim 10.

14. A method, comprising: producing a molded article with the foamed pellet material according to claim 1.

15. The method according to claim 14, wherein the molded article is produced by fusing or bonding of beads of the foamed pellet material to one another.

16. The method according to claim 14, wherein the molded article is a shoe sole, part of a shoe sole, a bicycle saddle, a cushioning, a mattress, a padding, a backrest, an arm pad, a pad, an underlay, a handle, protective film, a component in automobile interiors, or a component in automobile exteriors.

17. An article, comprising the foamed pellet material according to claim 1,
wherein the article is a ball, sports equipment, a floor covering, or a wall paneling.

18. A hybrid material comprising a matrix composed of a polymer (PM) and the foamed pellet material according to claim 1.

19. The process according to claim 11, wherein the blowing agent is selected. from the group consisting of butane, propane, pentane, carbon dioxide, and nitrogen.

20. A foamed pellet material obtained or obtainable by the process according to claim 11.

21. A method, comprising:
producing a molded article with the foamed pellet material according to claim 13.
